(19) United States
(12) Patent Application Publication
(10) Pub. No.: US 2011/0191083 A1
(43) Pub. Date: Aug. 4, 2011

(54) System and Method for Measuring and Reporting the Relative Functions of Dental Anatomical Structures

(76) Inventors: Bruce William Adams, West Vancouver (CA); Clive Wright, Vancouver (CA); Peter R.H. McConnell, Vancouver (CA)

(21) Appl. No.: 13/011,883

(22) Filed: Jan. 22, 2011

Related U.S. Application Data
(60) Provisional application No. 61/301,203, filed on Feb. 4, 2010.

(51) Int. Cl. G06G 7/60; G01P 15/00

(52) U.S. Cl. 703/11; 702/141

(57) ABSTRACT

The present invention provides a motion analysis system for measuring the relative function of one anatomical structure to another based on multiple accelerometer axis data, where the components of hard and soft tissue are used in analysis and where the data can be compared in a time series such that probabilities of involvement with various tissues can be correlated to the accelerometer data.

The invention measures acceleration at various positions and can relate the data to various muscle and other soft tissue variations within the constraints of the anatomy and physiology including motion in three dimensional space, including rotations and translations and any functions including velocity and displacement.

### FIELD OF THE INVENTION

The present invention pertains to the field of Dentistry and in particular to measurement of temporomandibular joint and occlusal relationships.

### BACKGROUND

The practice of restorative dentistry and treatment of the associated structures of the dentition and jaws has evolved such that the in depth analysis of the temporomandibular joints is generally not a part of routine dentistry. The issues surrounding centric occlusion, centric relation or the position of maximum intercuspation, are typically managed intuitively by dental practitioners.

Physical registrations at various positions of occlusion are sometimes used to provide additional information about the interocclusal relationships, especially when the practitioner is undertaking prosthodontic and restorative procedures. These are typically made by having the patient close their jaws together on some type of registration material such as wax or polysiloxane. Dental casts are typically mounted with this registration on an articulator and used to simulate the static relationship of the jaw in occlusion. The registration of centric occlusion is often used to describe the position at which the teeth come together and used in context with treatment to the dentition, especially the position of maximum intercuspation, however these measurements do not allow for functional analysis of the TMJ, and are subject to interpretation.

In practice, occlusal aspects of restorations may be fitted by trial and error on the model and adjusted in size and shape as needed until a satisfactory size and shape are attained. Mechanical articulators include an upper member and a lower member that are connected together by a pair of pivotal couplings (such as ball and socket joints). The model of the upper arch is connected to the upper member of the articulator, while the model of the lower arch is connected to the lower member of the articulator. In general, the couplings enable the two models to move toward and away from each other but cannot accurately mimic the certain movements of the patient's jaws.

As can be appreciated, however, the technique of articulation that is described above is time consuming and must be carefully executed to ensure that the resulting articulation properly records a useful relationship of the patient's occlusion.

Therefore there is a need for improved methods for measuring maxillo mandibular relationships and relating this information to a treatment plan.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for measuring and reporting the relative functions of dental anatomical structures. In accordance with an aspect of the present invention, there is provided a motion analysis system for measuring the absolute changes and relative function of one anatomical structure to another based on multiple accelerometer axis data.

In accordance with another aspect of the present invention, there is provided a biomechanical model of the maxilla, mandible and cranium that incorporates accelerometer data to create a mathematical representation of the cranio-mandibular relationships.

### BRIEF DESCRIPTION OF THE FIGURES

FIG. 1 illustrates an y axis and z axis plots of accelerometer data integrated to show displacement over time.

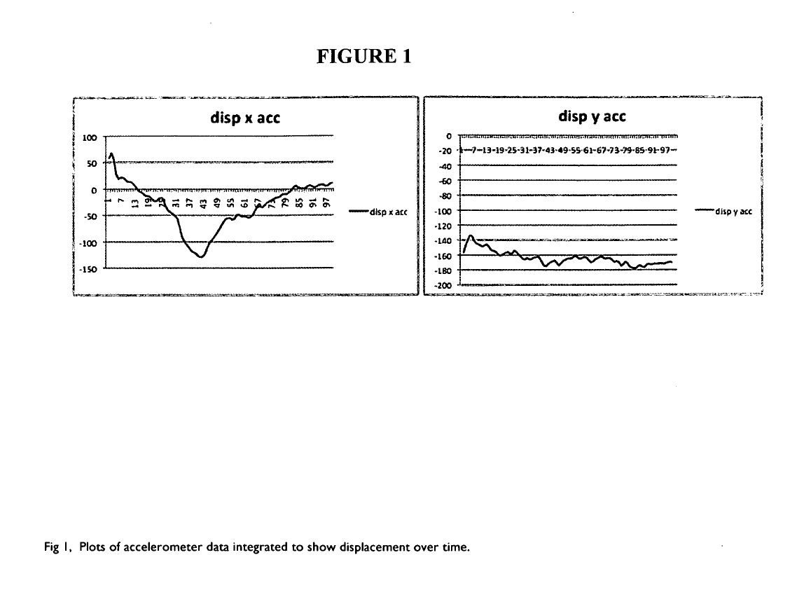

FIG. 2 illustrates plots of displacement data of the contact point of the condyle with the disk in the glenoid fossa. The data has been filtered to compensate for the rotations. High frequency data is still obvious.

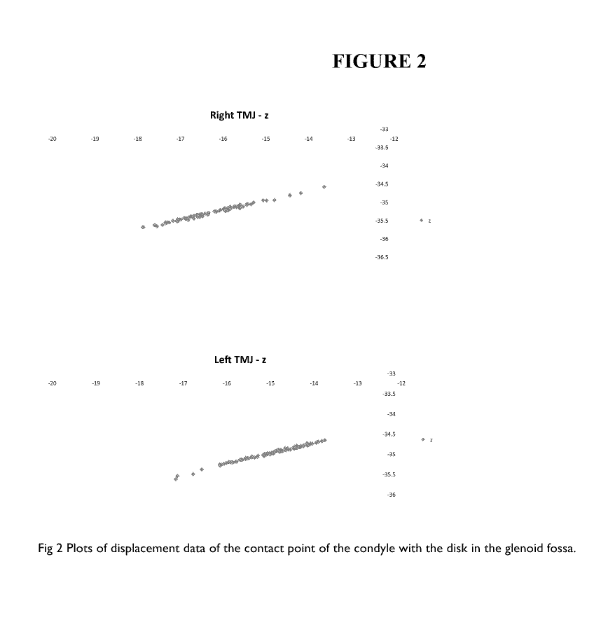

FIG. 3 illustrates incisal guidance and free translation without contact. The average vertical direction of the mandibular closing path is shown orthogonally to the more horizontal translations. The difference between muscle and tooth related guidance can be visualized comparing the vertical difference of the two more horizontal lines.

FIG. 4 illustrates Translation during occluded movement from the retruded position to centric occlusion compared in relation to free space movement in the same direction based on dental, muscle and temporomandibular joint guidance.

FIG. 5 illustrates opening with the effect of muscles causing retrusion as compared to closing from accelerometer data where opening muscles have relaxed.

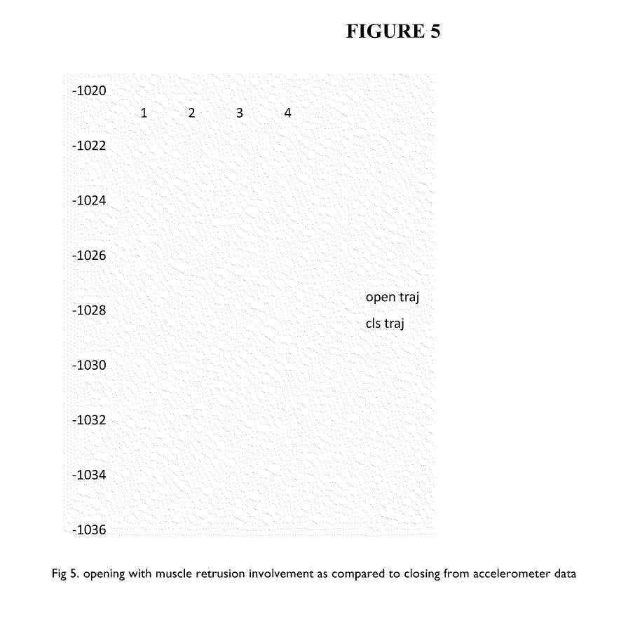

FIG. 6 illustrates a cross section of an ideal curve of spee based on free space movement and temporomandibular joint guidance from accelerometer data.

FIG. 7 illustrates right side translations based on free space movement and temporomandibular joint guidance from accelerometer data. Right buccal cusps require superior and retruded position of temporomandibular joint and possible masseter involvement.

FIG. 8 illustrates the position of the tooth contacts in relation to the right and left TMJ displacement plots, from accelerometer data. In this case maximum intercuspation area is working well in Gelb 4/7 position.

FIG. 9 illustrates the three accelerometer module triad in its axial plane configuration. Each accelerometer module has outputs of X,Y,Z data.

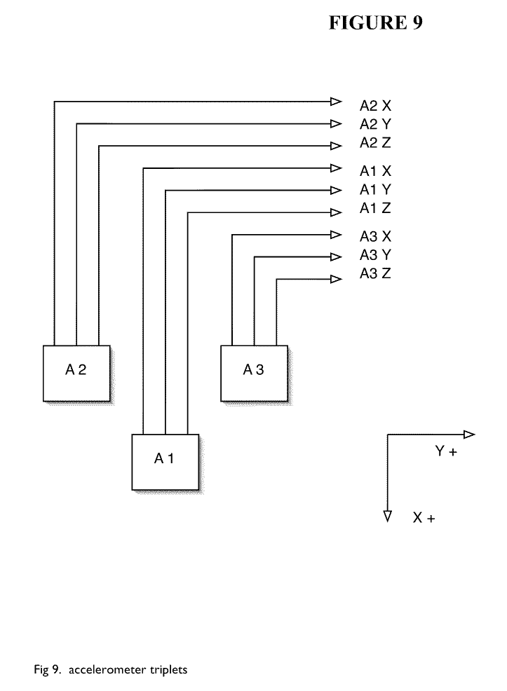

FIG. 10 illustrates the two module Accelerometer pair in its axial plane configuration. Each accelerometer module has outputs of X,Y,Z data.

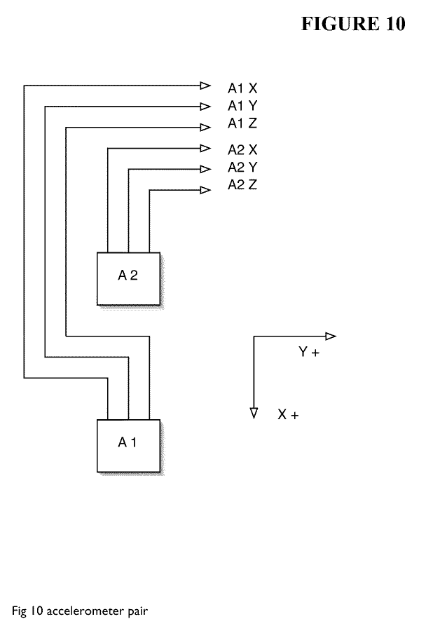

FIG. 11 illustrates how the orientation of planes is distinguished, using a line drawing of the jaw, as used in many medical imaging techniques. An X-Y-Z Cartesian coordinate system with the X-axis going from front to back, the Y-axis going from left to right, and the Z-axis going from up to down. The X-axis axis is always forward and the right-hand rule applies. An axial (also known as transverse or horizontal) plane is an X-Y plane, parallel to the ground, which separates the superior from the inferior. A coronal (also known as frontal) plane is a Y-Z plane, perpendicular to the ground, which separates the anterior from the posterior. A sagittal (also known as lateral) plane is an X-Z plane, perpendicular to the ground, which separates left from right. The midsagittal plane is the specific sagittal plane that is exactly in the middle of the body.

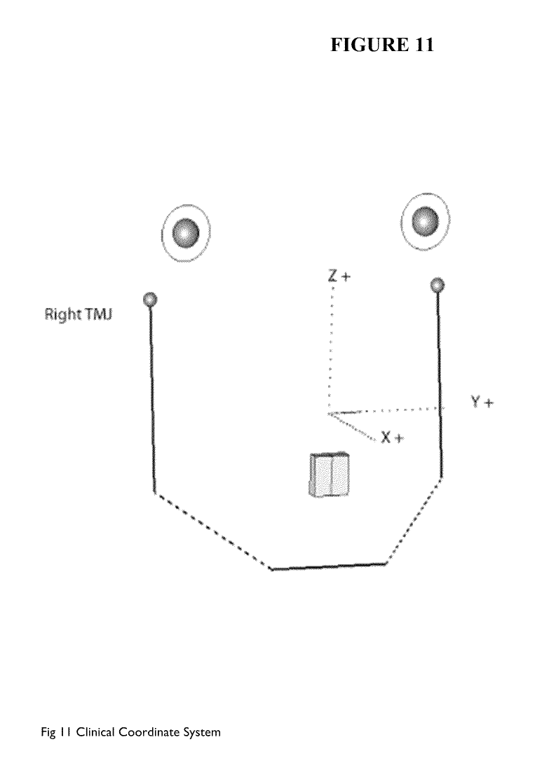

FIG. 12 illustrates the high level system architecture of the invention using data over the internet.

FIG. 13 illustrates the movement and analysis of data including protocol decisions, data transfer, integration of data into physical, biomechanical and timeline analysis and the reporting and visualisation process.

FIG. 14 illustrates muscle activity during protrusion when compared to normal.

FIG. 15 illustrates the method used to capture acceleration data from the accelerometer including incorporation with a Gyroscope.

FIG. 16 illustrates the position of one mandibular accelerometer module in reference to the X-Y-Z Cartesian coordinates. Other positions for opposing accelerometer modules are shown with one on the left and two on the right.

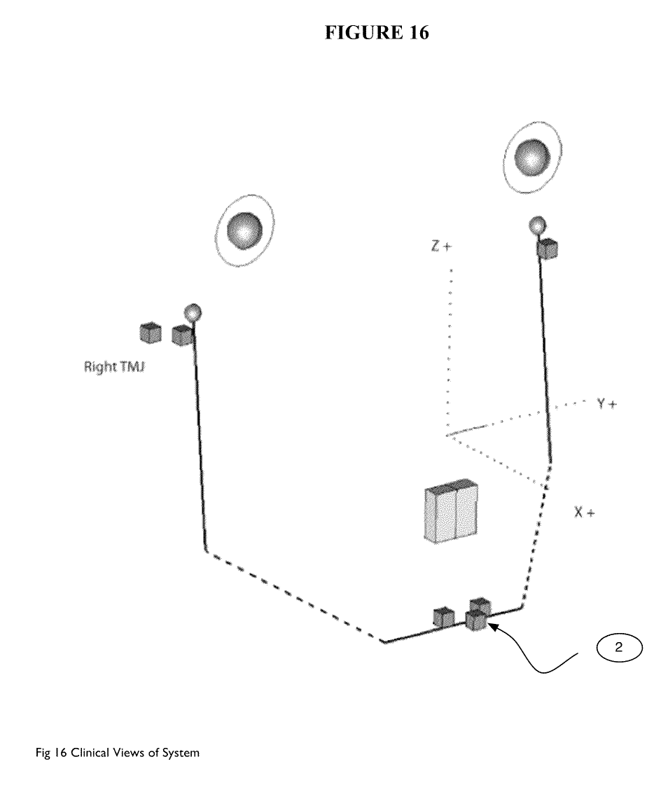

FIG. 17 illustrates the sample collection architecture.

### DETAILED DESCRIPTION OF THE INVENTION

### Definitions

The term “Centric Occlusion” is used to define the position of maximum intercuspation of the teeth, or other similar positions such as neuromuscular occlusion as would be known to one skilled in the art.

The term “Biomechanical Model” is used to describe a mathematical integration of data into a form where it can visualized and analyzed, including motion analysis with six degrees of freedom.

The term “Accelerometer Module” is used to describe a combination of accelerometers in a fixed orientation in order to best capture the necessary movement data.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The various aspects of this invention will become more readily appreciated and better understood by reference to the following detailed description.

The present invention provides accelerometer modules, such as a mandibular accelerometer sensor array, a cranial accelerometer sensor array, a means for capturing the data from the arrays, and means for communication of such data, a mathematical model of the biomechanics of this data, the biomechanical model and a means to display the such data and mathematical model that would enable one to make an analysis.

The object of the invention is to provide a means of analysis such that cranio-mandibular functions and structure can be easily correlated for treatment and data management.

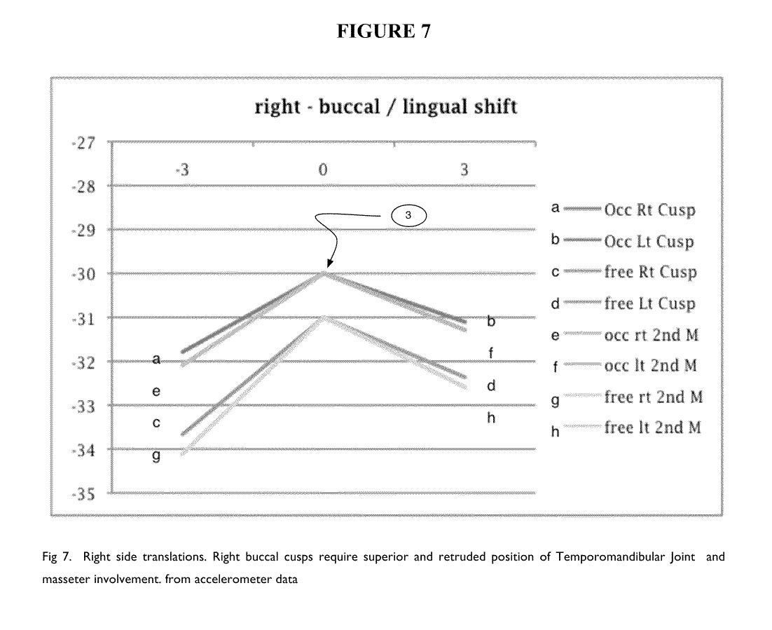

Data is presented in a manner to include details of cranial, maxillary and mandibular relations, include rotations and vectors at around all the standard and accepted conventions such as positions of occlusion, freeway space, or temporomandibular joint functions and to characterise normal and pathological functions FIG. 7. The associated analysis or analysis services could allow for knowledge to be shared between conventional dental laboratories and clinicians, 139. Laboratory services can be inclusive of diagnostic reports and data management. In this case the data and its presentation although separate from the data, become critical to the intuitive process of the clinician.

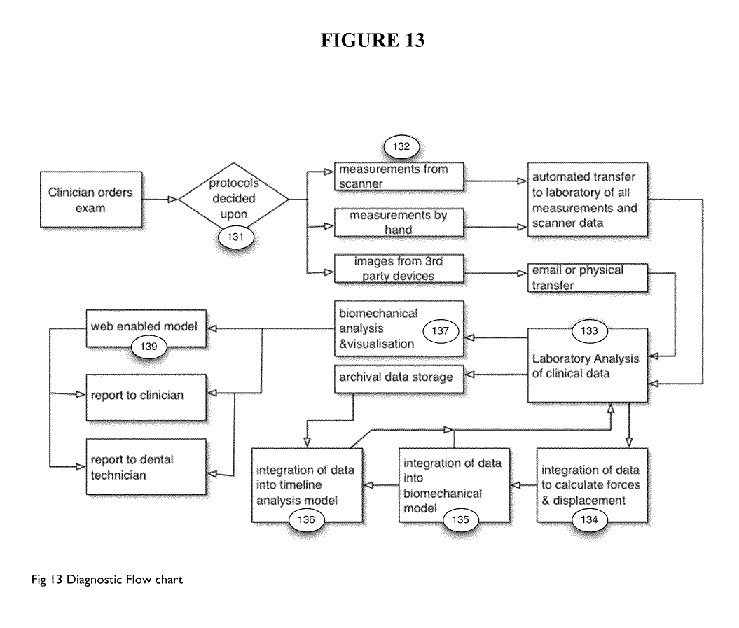

One aspect of the invention is to create a new method of occlusal analysis for use in dental clinics and laboratories. The invention may be used to compliment or even replace physical measurements and articulation of occlusion either by computer modeling or by mounting physical casts. In this regard another objective of the invention is to improve the communications with the laboratory, FIG. 13, without having a system that is cost prohibitive in the time required or be difficult to implement without substantial training.

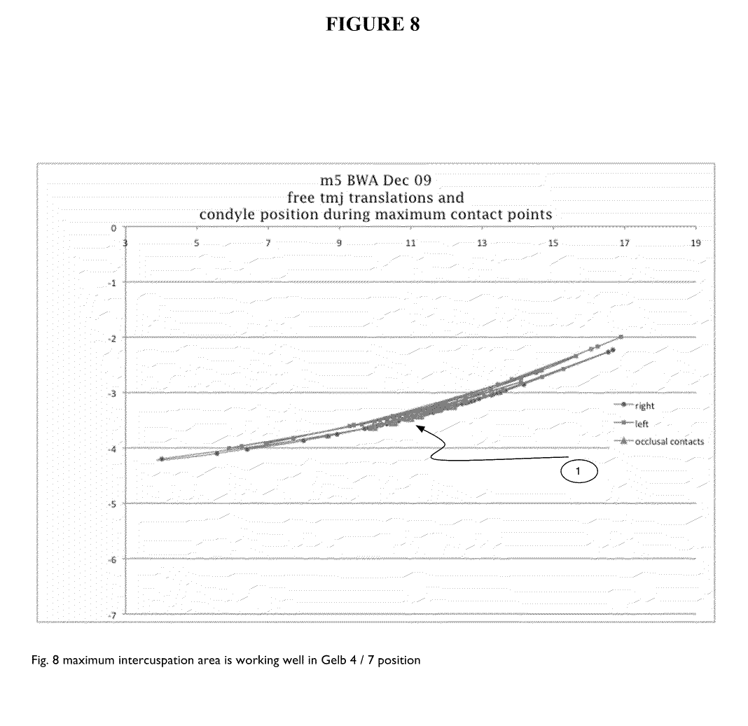

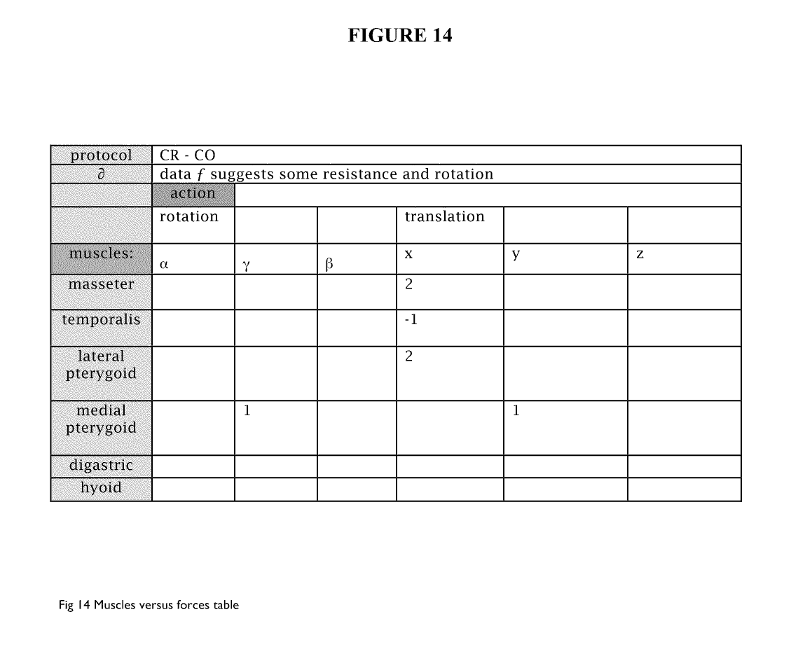

It is one aspect of the invention to measure the variations of the forces and or stressors that are induced upon tissue structures, FIG. 14, that may cause them to adapt by compression or stretching or long term morphologic changes. The motion of the mandible itself can be described as a rigid three dimensional body that can be measured within its constraints of free movement of its six degrees of freedom, in three dimensional space. The forces and stresses are important components of the required physical measurements of the mandible that should be measured to obtain a comprehensive evaluation of the mandibular motion relative to the maxilla. Some or all of these maxillo mandibular relationships are important depending upon the type of dental clinical and laboratory treatment that is undertaken. Accordingly, it is one aspect of the invention to be able to measure some or all of the maxillo mandibular relative functions. The relationship between the maxilla and the mandible is not fixed and its centers of rotation, FIG. 8, are not constant and it is useful to be able to measure such changes. The rotational axis of the mandible can depend on the degree of soft tissue compression such as with the articular disk and the centers of effort for the many muscle and ligament origins and insertions. Accordingly it is one aspect of the invention to be able to measure the position of the condyle and simultaneously the impacts of muscle involvement as this information can be used to infer soft tissue compression. The slope of the articular eminence also has a significant impact on the actual movement. The condyle of the mandible may rotate and translate in the articular fossa to a varying degree depending upon the forces acting upon it. It can therefore be seen that the invention is a system and a method of clinical and laboratory practice where the architecture and function of the jaw and teeth can be measured and collected as electronic data.

Accordingly the invention is to be used in comparing the form and function of not just the tooth occluding surfaces and temporomandibular joints, but also the entire crainio mandibular system including but not limited to bones, teeth, muscles, ligaments and nerves and further providing graphic representations of the changes that would not be obvious from manual methods of trying to determine the function from the structure, such as comparing opposing tooth surfaces. This is especially the case for dentists and doctors such as maxillofacial surgeons, ear nose and throat specialists, and laboratories and technicians providing prosthetic, tooth positioning and occlusal appliances. Three dimensional force and movement data with six degrees of freedom, of both maxillary and mandibular activity, can by the use of the invention, be made available and can be compared to the structure, and function of the stomatognathic system. Clinical procedures which require interpretation of functional data such as occlusion, will by this invention, be able to document or record those functions using standard protocols, 131, described herein.

Still yet further, another feature of the invention is to create a speed advantage over existing procedures. Rather than using mechanical methods to record a patients structure and function a protocol of patient scans can be enabled with the invention.

Since the center of soft tissue rotation may not be the same as that as directed by the bony structures, then there is likely to be a varying level of soft tissue compression as the mandible is put under rotational or translational stress.

Since the actual position of the centre of force is not fixed, the invention can make calculations of the changes inherent on the mandible by measuring its rotations and translations during different functions. For instance the rotation and translation of the mandible is different in many people such as when they are under stress from physical exertion as compared to talking, eating or other normal functions, and changes in centre of rotation can be highlighted, 1, FIG. 8.

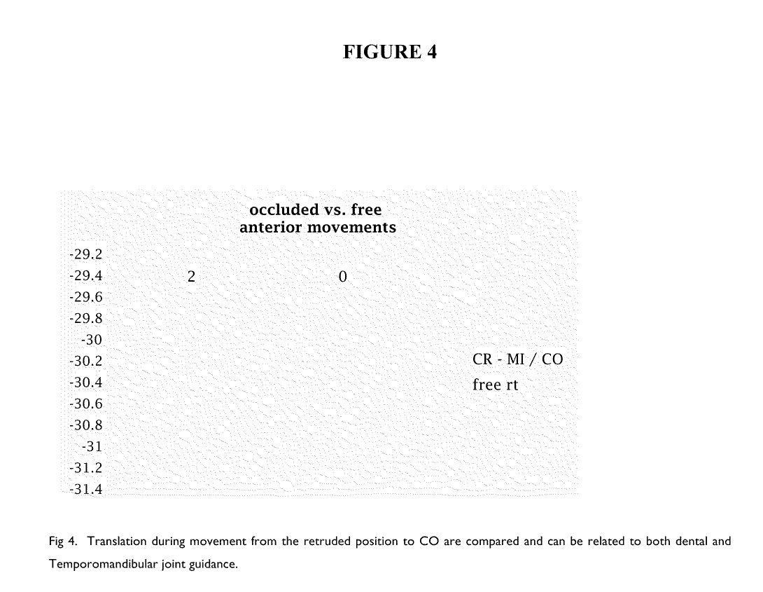

In fact the measurement of the forces under exertion may create a completely different occlusal relationship, than that of what is considered as centric occlusion FIG. 4. Furthermore a forced occlusion may be in a position that if not balanced could be causing soft tissue stress or could be putting the masticatory nervous system under such stress that it could impact other systems in the body. As a result it is one objective of the invention to be measuring the variations between normal and high strain rotations and translations.

In one embodiment the accelerometer modules have three, three-axis accelerometers as a module, 2, in a mandibular harness and three, three-axis accelerometers as a module in a maxillary harness. The accelerometer modules are constructed in a system such that each of the accelerometers has a fixed relationship of the accelerometers to each other within the module. This configuration and can be used in the biomechanical model, 135, to measure the changes in the plane of their rigid body in euclidian space. In turn the maxillary and mandibular relationships can also be determined. The use of two sets of three accelerometers allows for the ability to measure, and subsequently visualise, with six degrees of freedom the absolute changes in acceleration, velocity and displacement of the mandible and also the maxilla and subsequently the relative movement including force vectors and rotations, of the mandible to the maxilla such as the plane of occlusion of the mandible to the plane of occlusion of the maxilla. The rotational components of any dental or mandibular structure can be described in terms of the rotational component of the accelerometer data versus the translational component of the accelerometer data.

In one embodiment of the invention, an accelerometer module is small enough that it can be used either intra-orally or extra-orally without cumbersome or bulky apparatus or fixation procedures which would interfere with the clinicians duties of assisting the patient while using the invention for recording the changes in physiology or kinematics.

The invention performs an analysis of the acceleration at various positions so that the relative motion can be related to the various muscle and other soft tissue variations and compared as might be expected within the constraints of the maxillo-mandibular anatomy and physiology.

In a slightly different embodiment, which is a simplified modification of the first example, the accelerometer module has only two accelerometers on the mandible. This may be all that is required in many situations as the second accelerometer is placed to provide corrective measurements of the Euler rotations around the vertical axis rotations. These are critical to measuring the rotations during cuspal alignment or tissue compression.

In one embodiment a gyroscopic sensor is used in conjunction with the accelerometer modules. A MEMS based rate gyro can be added to the sensor system, to increase the accuracy of the accelerometer-based results, up to three gyroscopes can be provided including one for each of the accelerometer sensors, or one for each accelerometer module or up three gyroscopes could be configured to work with one accelerometer. Their outputs are incorporated by integrating the accelerometer and gyroscope outputs using a Complementary Filter, Kalman Filter, or similar Filter. This is sometimes referred to as Sensor Fusion. The Complementary Filter uses two orientation estimates, with differing noise characteristics, to produce a single orientation estimate combining the advantages of each. It is important to note that due to the complementary nature of the filter there is no group delay in the filter response.

The first estimate is an absolute estimate calculated from the measured acceleration and magnetic field vectors. These two vectors are used to directly calculate the rotation matrix relative to the Earth-fixed frame. The acceleration vector provides one basis vector, the Earth's magnetic field projected into the X-Y plane provides the second, and the cross product the third. This estimate has the advantage that it produces an absolute estimate but suffers from movement induced error due to dynamic accelerations.

The second estimate is a relative estimate produced by integrating the outputs of the rate gyroscopes. This estimate produces smooth movement with very low latency, but suffers from low frequency drift due to gyroscope null offset accumulation and numerical integration errors.

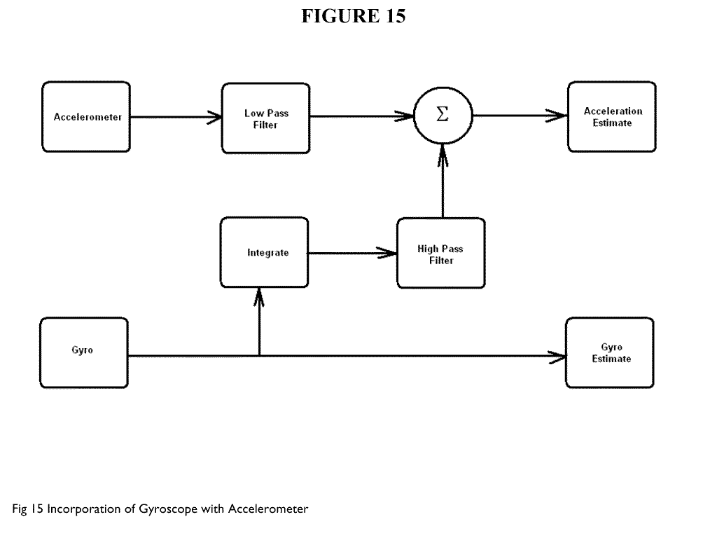

These two estimates are used as inputs to the Complementary Filter, utilizing the best qualities of each individual sensor to obtain a combined output of both sensor estimates FIG. 15.

Examples of gyros are the ADXRS150 from Analog Devices. Measurement of the pitch, yaw, and roll rates can be combined into a multi-axis gyro using a two axis or three axis gyro such as the LPR430AL or LYPR540AH from STMicroelectronics respectively. Measurement of the acceleration can be made using devices such as the STMicroelectronics LIS302DL 3-Axis accelerometer.

The combined outputs of the filter provides a fused of refined estimate of the accelerations experienced by each of the sensor points. This output can be further filtered to enhance or extract specific features of the movement of the sensor affixed to the jaw. Such features may be things like a temporomandibular joint click, or correlation to muscle activity. In this case a matched filter is applied to the measured signals to extract the presence of such features at levels that would not normally be observable. Other filters such as simple lowpass, bandpass, and high pass filters are used to extract low frequency, high frequency, and specific frequency characteristics of the jaw dynamics as the jaw is exercised through a prescribed set of motions. These filters can be of the finite impulse response or infinite impulse response if implemented digitally, or any of the many forms of analog filters.

In order to use accelerometer data to characterise function, the reported values must first be integrated to characterise velocity and integrated again to characterise displacement.

This is well known and understood to those in the art. However, due to the unique combination of accelerometers, the data of each accelerometer can be used to calculate the rotations of the jaw and can be used in an integrated biomechanical model, 134.

### Data Analysis

The invention may be used to measure the resistance in various muscle groups and correlate the resistance to diagnostic criteria such as the ideal design and three dimensional variations from an the curve of spee; the resistance vs. compression of the temporomandibular joint; the axes of compression on joint tissues; and on compression of dental occlusal and alveolar structures, including the axes of the forces involved in relation to the axial alignment of the teeth or prosthetics.

Such relationships can include mechanical computations of such things as inertia, resistance, repeatability, stress, positions and their co-relationships. In the biomechanical model the invention can reference three-dimensional movements of the jaw to the forces and characterise the relationship of the velocity and force such that one can reference the muscle activity as a function of movement, FIG. 14.

The invention can be used as a method of presenting standardised dental documentation and procedures. Analysis of the temporomandibular joint is being done in specific ways and represents a standard test to relate temporomandibular joint function to occlusal function. In other fields, document designers have created sets of documents which all share a common structure. In this case the document created is a combination of prescription, protocol and analysis that can be created as part of a patient record, whether digital or otherwise, and which can incorporate digital simulation records.

The clinician could incorporate data from a normalised photographic image or data from manual measurements to adjust the biomechanical model to be patient specific. Such data could include some basic biometrics such as jaw width between condyles, length of the ramus and sagittal length, and whether or not using a face bow, some basic information about vertical and anterior/posterior position of the dentition and could also include imaging data from other devices such as three dimensional computerized scans of the occlusal surfaces, 132.

A prescription or treatment plan, would involve choosing from a series of scans from a list including the following:

open/close relax;
relaxed and still at non contact 2-3 mm freeway;
measure with TENS or other positioning protocol;
incisal guidance and anterior freespace guidance;
lateral guidance and lateral freespace guidance;
Comfortable wide opening and far lateral excursions rt./lt.;
Anterior guidance from CR-CO.

### Data Display

The series of scans represent a protocol or a standard analysis and a format of common structure for using accelerometer data in a clinical setting. It also represents the style for which a set of documents for temporomandibular joint analysis and occlusal analysis can be performed. These documents may be in the form of images or formats for a class of occlusion and temporomandibular joint analysis documents. This further simplifies the task of creating and interpreting multiple scans by providing a predefined set of options within which to work.

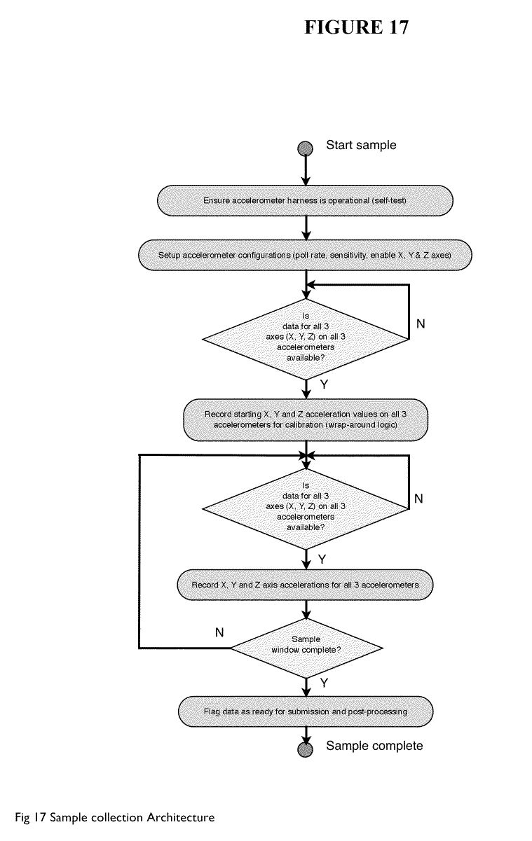

In one embodiment the invention provides an analysis that can be used as a document graphic or multi dimensional computer graphic representation, of the acceleration data compared to relative positions of anatomical structures or the relationship between anatomical structures, 137. The acceleration data can be further enhanced with data to demonstrate the changes in both velocity and displacement. FIG. 17 shows acceleration data overlay for the internal slopes of the cusp of a posterior 2nd molar vs. that of the cuspid guidance.

### A Biomechanical Model

The Biomechanical model of the jaw can be used and customised for each patient. This model is analogous to a fully adjustable dental articulator, however, able to compensate for soft tissue variations in a way that no other model might be able to do as it incorporates the contractile and elastic components in each type of tissue. This model will be useful for either the clinician or support personnel including laboratory personnel. The biomechanical model can be used for instantaneous evaluation or compared in a time series, 136.

Accordingly the biomechanical model incorporates physical measurements with respect to the angle of the jaw, the ramus, the condyle, the width between the condyles in the frontal plane and other details as would be necessary to describe the anatomy. Such measurements could be patient specific or based on standardised normals or some combination thereof. The biomechanical model can relate the forces from muscle activity as can be interpreted based on changes in acceleration as the jaw functions. These can in turn be used to correlate to such conventions as centric occlusion, or bennett shift and other well known terms that relate to function, but with the added data to compare ideal form to actual form and to compare forces versus actions.

### Measurement of Lateral Function

In one embodiment the invention can use its biomechanical model for the comparison of lateral functions of the jaw with the teeth in occluded contact vs. the lateral functions of the jaw without any contact of the dentition. In this case the patient moves the jaw laterally from centric occlusion while maintaining occlusal contact. Similarly the patients move the jaw laterally from a relaxed position with some freeway space from centric occlusion. FIG. 7, shows the difference between occluded and non occluded movement from the position of centric occlusion, 3.

### Measurement of Muscle Interferences on Accelerometer Data

The position of the jaw can be tracked versus the muscles and ligaments involved in the biomechanical model by comparing the acceleration and deceleration. High and low frequency data can be processed to correlate to muscle groups during certain functional positions of the mandible to the cranium. Muscle activity and resistance could be part of a standardised model or as part of an iterative process using prior data from a subject.

A normalised database that provides reference data of the contractile and elastic components in each type of tissue that would control the jaw function. Changes in acceleration can be referenced with the biomechanical model related to different types of functions. For instance, the movement of opening and closing the jaw uses the components of movement differently from the movement of anterior translation while in occlusion.

The invention provides an analysis that can be used to describe the function of the muscle movements compared to accelerometer data, based on the measured or statistical anatomical relationships of the cranio-facial muscles. A biomechanical model of the maxillo-mandibular function can be manipulated by the input of accelerometer data. Such a model might for example infer the actions of hyoid muscles vs. pterygoid muscles.

The form of the dentition might further be associated with the posture of the jaw and the posture of other parts of the body such as cervical spine and anterior head posture. Such relationships might involve adding manually measured variables of the spine or other body structures into the analysis.

### Measurement of Forces, Including Angular Guidance on Tooth Positions

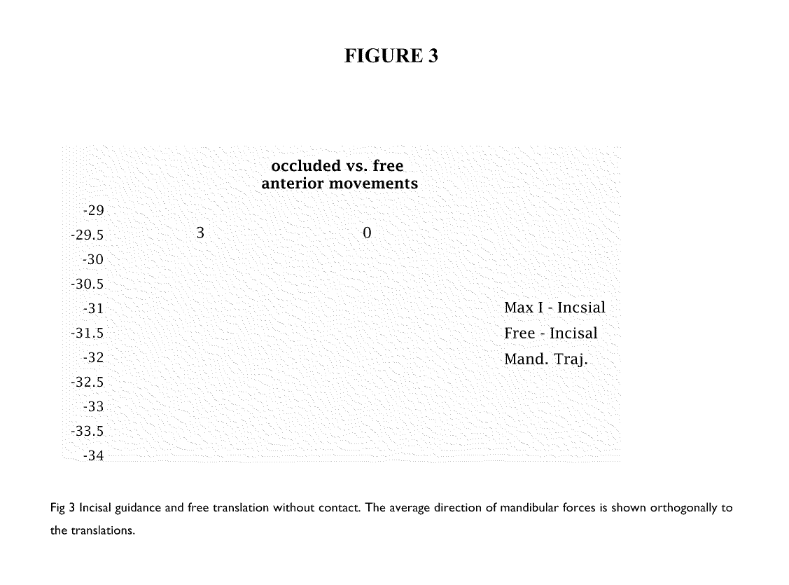

The motion of the jaw has impacts upon the teeth as they come into contact FIG. 3, and contact points and the axial inclinations of the teeth can be compared including the ideal relationships to compare the vectors of the forces of occlusion in comparison to the actual or proposed positions of teeth.

### Measurement of Forces on Temporomandibular Joint Positions

The position of the condyle in the glenoid fossa can be tracked as seen in FIG. 8. The temporomandibular joint functions can be compared when measured both with and without stress, including measurements made when in a relaxed static posture vs. that of a clenched posture. The muscle involvement is compared with the normal vectors compared to those at stress vectors. Other features of temporomandibular joint position can be evaluated and determined including: articular disk position can be calculated from the presence or absence of abrupt changes as compared to the normal or to a time series; the centre or resistance and total joint resistance and compression can be calculated from the variations in movement during diagnostic scans and also from changes as compared to the normal or to a time series; joint laxity can be calculated by comparative scans that show lack of repeatability in translational position or changes as compared to the normal or to a time series, especially in the changes in high frequency data; clicks and crepitus can be calculated by comparative scans that show the variations in high and low frequency data or changes as compared to the normal or to a time series. A computed model of temporomandibular joint biomechanical function can then be created that integrates accelerometer data and can be visualised and compared over time.

Deriving Ideal Form from Function.

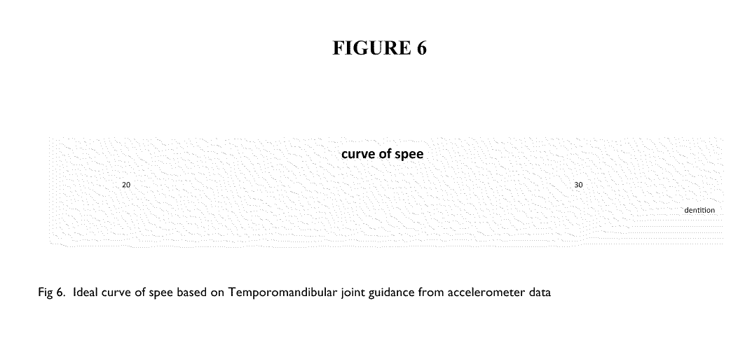

In one embodiment of the invention, the ideal shape and relationship of the maxillary dentition in comparison to the anatomical structures of the mandible and its functional components can be calculated such that an ideal curve of spee FIG. 6, can also be calculated and or displayed as a complex curve or three dimensional shape or multi dimensional analysis such as temporomandibular joint morphology compared in a timeline. The timeline might be a forward looking projection based on how the muscles and stressors might cause hard and soft tissue changes over a variable age of a subject.

The greater proportion of dental treatments can be completed using this method with reasonable knowledge of the position of the temporomandibular joints and their actions. The measurements are easily made and easily become part of standard treatment protocols such as would be incorporated into routine clinical practice with analysis of the patients centric occlusal and centric relation zones and other such anatomical relationships well documented to a standard protocol.

### Laboratory Method of Describing and or Machining of an Occlusal Reference

In one embodiment of the invention, the data can be used to produce a list of the settings to allow laboratory technicians to manually adjust articulators, such a setting based on the accelerometer data alone or in conjunction with clinical measurements. In articulators that can accommodate inserts for condylar guidance or for incisal guidance, then these inserts could be automatically machined based on the biomechanical model. Likewise, occlusal paths such as the idealised curve of spee, could be machined to allow clinicians and technicians to understand and manage the anterior and posterior three dimensional space of occlusion. In the case where an analysis is being made or a prosthesis is being designed on a computer, the invention can provide reference data that would be used for programming an adjustable, digital or virtual maxillo mandibular relationship and these relationships could be transferred to digital data and allow the direct or indirect machining of a prosthesis or a reference component for manufacturing a prosthesis with a laboratory procedure, whether digital or using conventional procedures as would be known by one skilled in the art.

Other existing diagnostic solutions can be combined with the accelerometer data and used in the biomechanical model for further diagnosis. Such data could be measured with existing diagnostic devices for analysis of dental features can include solutions such as radiographs including peri-apical and panoramic or cephalometric images, manual anatomical measurements, such as jaw size, video and photographic images, simulations, intra oral force measurements, kinesiographs, face bow tracings, three dimensional scans of the actual dentition or of impressions or casts made from the actual dentition or scanning data from MRI or CAT scan data comparing function or state of the temporomandibular joint.

### Mechanical and Electrical Considerations

The invention may to be mounted to the jaw, head or teeth by means of temporary cement, a means of a harness and or straps, or with a bite fork system that can be used with any of the standard methods of incorporation of a relationship with a dental articulator or other methods of jaw measurement as would be widely know in the art of dental practice.

In another embodiment the invention has a wireless connection such that the accelerometer modules and their rigid mount are in turn mounted to the mandible without being directly tethered to the system.

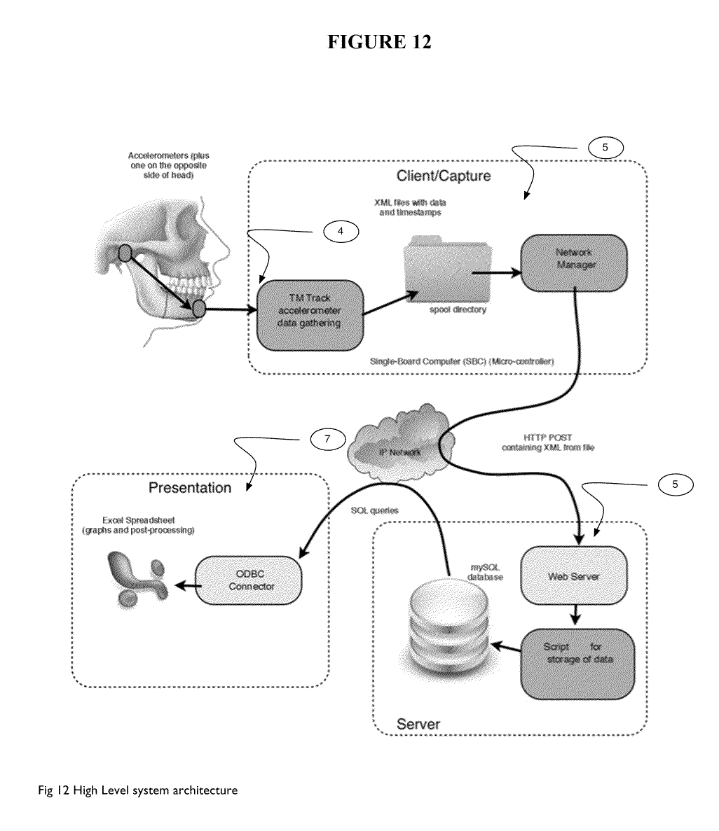

In one embodiment the data capture side of the invention consists of a system connected to a single board computer, where all data storage is kept offsite in a database with reports and analysis being handled by an offsite lab service as shown in the high level system architecture, FIG. 12.

A micro-controller board can be used, such as a single board computer, that runs a multi-tasking operating system kernel, industry standard networking software and some custom-written software modules that can capture data, 5, from the accelerometer module, 4, and submit that data to an internet-based server for post-processing, 6, and analysis, 7.

The accelerometer modules on a harness are connected to the micro-controller via a custom wired cable arrangement allowing all three accelerometers to reside on the same digital bus along with some chip select logic to allow individual access to each of the three modules independently of each other.

The micro-controller capture software, FIG. 17, configures and calibrates the accelerometer modules before starting its capture window. During the capture window it waits for X, Y and Z axes gravity coefficients to be ready to read from all three accelerometers which effectively produces reasonable synchronization of captures from the accelerometer modules, then reads all of these values are stores them in memory. A fixed delay is then implemented to ensure the captures are evenly spaced. Captures continue on a timed basis until the capture window is over.

Once the capture window ends the capture software writes the captured data, along with it's timestamp and other pertinent information, to a file formatted using the XML markup language.

The micro-controller reporting software then picks up any XML markup language files that are ready on a regular basis and submits them, across the Internet, to the dental analyzer server using a protocol such as an HTTP post. The mechanism allows for file retries and storage until a network connection becomes viable.

The server side of the dental analyzer consists of industry standard web server software with custom-written scripts for submitting received XML markup language data files, from the invention clinical data capture units, into the dental analyzer database; industry standard web server software with custom-written scripts for submitting received XML markup language data files, from the dental analyzer capture units, into the dental analyzer database; industry standard SQL database server software with custom-designed table structures for accommodating the dental analyzer capture data sets.

In one embodiment the server could be localized at the clinical capture side: The data from all axes including rotations may be used with other circuitry and systems as would be normal for one skilled in the art of electronics design.

### Signal Processing Method for Noise, Artifacts, and Missing Data

The accelerometer data is filtered to be sensitive to the frequency of movements to be measured. For instance, the broad movements of opening and closing show a different frequency distribution than the vibration of the jaw in a static position. By describing the low vs. the high frequency data relative to the displacement of the jaw the signal processing system can reduce the noise in the data, and also point to patterns that might be useful in determining the normal functions, or pathophysiology and the correlation of muscle activities, 133.

### Noise and Artifact Sources

The data is also filtered to remove noise and interfering signals. Accelerometer data can be contaminated by noise and artifacts that can be within the frequency band of interest, and can manifest with similar morphologies as the accelerometer data itself. Broadly speaking, noise contaminants can be classified as:

Power line interference, especially in areas with substantial medical equipment; Baseline calibration and drift; Sensor pop or contact noise: Loss of secure contact between the accelerometer module and the patient and the skin manifesting as sharp changes for periods of around 0.1 second; Patient versus system motion artifacts such as movement or imbalance of the accelerometer module away from the contact area on the skin or teeth, usually manifesting themselves as rapid, but continuous, baseline jumps or complete saturation for up to 0.5 second; Data collecting device noise such as artifacts generated by the signal processing hardware, such as signal saturation; Electrosurgical noise such as noise generated by other medical equipment present in the patient care environment at frequencies between 100 kHz and 1 MHz, lasting for approximately 1 and 10 seconds; Quantization noise and aliasing; Signal processing artifacts (e.g., Gibbs oscillations).

Although each of these contaminants can be reduced by judicious use of hardware and experimental setup, it is impossible to remove all contaminants. Therefore, it is important to quantify the nature of the noise in a particular data set and choose an appropriate algorithm suited to the contaminants as well as the intended application as would be well known to one familiar with the art.

The invention will now be described with reference to specific examples. It will be understood that the following examples are intended to describe embodiments of the invention and are not intended to limit the invention in any way.

### EXAMPLES

### Example 1

One example of the invention is to be able to compare the form of the physical dental and jaw structures to their function. Where a single position might have previously been limited to one location, such as the probable position of centric occlusion, a functional analysis with the invention could enable the ability to look at occlusion as a comparison of forces and zones of interaction. So rather than provide clinical or laboratory personnel who are tasked to enable changes to a restoration or appliance with extremely limited information, less than what is ideally required to a complete their task, the invention provides clinicians and technicians detailed data regarding the rotations and translations of the relative maxillary and mandibular relationships.

### Example 2

In another example of the use of the invention, data can also be related to methods used normally such as recording the structure with impressions of the teeth and the subsequent articulation of casts with mechanical bite registrations. In this way the invention can use automated records of occlusion compared to such information that might be obvious from examining the wear facets on the casts such as group function of the teeth. The invention can be used to relate multiple versions of occlusal registrations that would be used to relate articulated casts in their static position to function, either intuitively by the clinician or technician, or to adjust a computer model or adjustable articulator. The invention would provide further information as might not normally be available such as tissue compression in the temporomandibular joint, or axial stress upon the teeth or from alveolar arch tissue under a prosthesis or surrounding an implant. In the case of an implant, a most important issue is to determine the relationship of axial forces of occlusion vs. the angle of the implant. This critical information will help technicians to build restorations with considerably less risk of failure.

### Example 3

In another example of the use of the invention, an analysis system and method is used to characterize the relationship between structure and function providing a solution for routine clinical analysis of centric occlusion, centric relation and axial forces, translations and rotations such that the information and data is easily correlated or visualised in two or three dimensions in comparison to any other point in the occlusion or temporomandibular joint. The movement data that relates to the position of the mandible in relation to the maxilla can be used to interpret the rotational and translational loading on the temporomandibular joint. The muscle bearing loads can be established and their impacts on the centre of effort or centre of rotation can be calculated.

### Example 4

In another example of the use of the invention, the mandibular accelerometer module is configured to be used with the largest distance that is reasonable between the centers of the accelerometers such as 60-100 mm, in order to reduce the impacts of vibrational noise on the resultant data.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

The embodiments of the invention in which an exclusive property of privilege is claimed are defined as follows:

1. A system comprising single or multiple axis accelerometers where the integrated data is used for motion analysis including measuring the absolute changes and relative function of one anatomical structure to another where such structures are considered as rigid bodies and may include surrounding hard and soft tissue.

2. The system in claim 1, where a gyroscope is used to augment the accelerometer data.

3. The system in claim 1, where the components of hard and soft tissue are used in analysis and where the variables can be compared in a time series including velocity and displacement, such that the accelerometer data can be correlated to probabilities of the involvement of various tissues.

4. The system in claim 1, where the rigid anatomical structures are the mandible and maxilla and bones of the cranium, and include the hard tissue of the temporomandibular joint.

5. The system in claim 4 where a motion analysis system measures the absolute and relative dynamics of the mandible and or the maxilla in three dimensional space, including rotations and translations.

6. The system in claim 4 where a motion analysis system measures the acceleration of the jaw and can correlate this to various scalar, vector and tensor functions.

7. The system in claim 4 where a motion analysis system measures the acceleration of the jaw and can correlate this to a subjects physiology such as muscle activity, or hard and soft tissue relationships.

8. A biomechanical model of the maxilla, mandible and cranium that incorporates accelerometer data to create, or assist in the creation of, a mathematical representation of the cranio-mandibular relationships such that the plane of the mandible can be compared to the plane of the maxilla with six degrees of freedom.

9. The system in claim 8, where the biomechanical model can analyze dental cuspal relationships, including rotation, translation and static positions and including occlusal contacts, interocclusal space, lateral and incisal guidance, and the position of the condyle in its fossa and other hard and soft tissues related to dental and oral health.

10. The system in claim 8 where data selected from the group comprising of manual inputs, diagnostic images, gyroscopic data, sensor data and three dimensional scanning data, can be incorporated to improve the accelerometer data and compensate for soft tissue such as the contractile and elastic components in each type of tissue.

11. The system in claim 10 where data and can be used for instantaneous evaluation or compared to a time series.

12. The system in claim 8 where a documentation protocol of the measured accelerometer data and the biomechanical model can be used to demonstrate the changes in the data in context with existing protocols, such that its use in clinical practice would have standard documented procedure.
